(19) United States
(12) Patent Application Publication
(10) Pub. No.: US 2010/0181265 A1
(43) Pub. Date: Jul. 22, 2010

(54) Shale shaker with vertical screens

(76) Inventors: David L. Schulte, JR., Willis, TX (US); Paul Dufilho, Willis, TX (US); Thomas Larson, Montgomery, TX (US)

Correspondence Address: National Oilwell Varco, c/o Williams, Morgan & Amerson, 10333 Richmond, Suite 1100, Houston, TX, 77042, US

(21) Appl. No.: 12/321,358

(22) Filed: Jan. 20, 2009

(51) Int. Cl. B01D 33/03; B07B 1/46; B07B 1/28

(52) U.S. Cl. 210/785; 209/397; 209/360

(57) ABSTRACT

A screen assembly for a vibratory separator, the screen assembly vertically-mountable and further including a support, at least two screening faces on the support, said at least two screening faces each including screening material through which fluid is flowable from outside the screen assembly into a space within the screen assembly and interiorly of the at least two screening faces, and the support including an exit from which fluid may exit from within the screen assembly; shakers with at least one such screen assembly; and methods of using such a screen assembly in a vibratory separator. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 CFR 1.72(b).

### BACKGROUND OF THE INVENTION

1. Field Of The Invention

The present invention is directed generally to: shale shakers and vibratory separators; screen assemblies for them; such shakers and separators with one or more vertically mounted screens with dual spaced-apart screening material members; and to methods of use of these things.

2. Description of Related Art

The prior art discloses a variety of vibratory separators and shale shakers. Vibratory separators are used in a wide variety of industries to separate materials such as liquids from solids or solids from solids. Shale shakers are used in well drilling operations to separate reusable drilling fluid from drilling fluid with solids entrained therein. Typically such separators have a basket or other screen holding or mounting apparatus mounted in or over a receiving receptacle or tank and vibrating apparatus for vibrating the basket. One or more screens are mounted in the basket. Material to be treated is introduced to the screen(s) either by flowing it directly onto the screen(s) or by flowing it into a container, tank, or “possum belly” from which it then flows to the screen(s). Also in some multi-screen apparatuses material flows from an upper screen onto a lower screen.

U.S. Pat. Nos. 3,968,033; 4,846,352; 5,226,546; 4,224,146; 4,744,898; 6,179,128; 4,040,951; 4,303,509; 5,332,101; 6,401,935; 3,718,963; 6,179,128; 5,392,925; 4,882,054; 4,582,597; 2,630,225; 6,371,301; 6,863,183; 7,198,156; and 7,216,767 (all incorporated fully herein for all purposes) and the references cited therein disclose a variety of separators, shakers, and screen assemblies. U.S. Pat. No. 7,216,767, co-owned with the present invention, discloses vertically mounted screens with one screening material face.

### SUMMARY OF THE PRESENT INVENTION

The present invention, in certain aspects, discloses a vertically mounted screen assembly for a vibratory separator or shale shaker which has a frame and two, three, four or more screening members. Fluid flowing through a screening member flows into an interior of the screen assembly and then flows within the screen assembly to an exit opening or openings from which the fluid flows to a collection receptacle or transmission conduit. In one aspect, the exit opening (or openings) is in the bottom of the screen assembly. In other aspects there is an opening (or openings) in a side (or sides) and/or in a top of the screen assembly.

In one particular aspect, pumping suction (or a vacuum) is applied to an exit opening of a screen assembly according to the present invention to facilitate evacuation of material (e.g. fluid or fluid with some solids) from within the screen assembly.

The present invention discloses, in certain aspects a vibratory separator or shale shaker with one or a plurality of vertically mounted screen assemblies according to the present invention.

The present invention discloses, in certain aspects a screen assembly for a vibratory separator (e.g. a shale shaker), the screen assembly vertically-mountable and including: a support, the support vertically mountable in a vibratory separator; at least two screening faces on the support, the at least two screening faces each including screening material through which fluid is flowable from outside the screen assembly into a space within the screen assembly and interiorly of the at least two one screening faces; and the support including an exit (an opening or openings in structure of the support) from which fluid flowing through the at least two screening faces exits from within the screen assembly.

Accordingly, the present invention includes features and advantages which are believed to enable it to advance vibratory screening technology. Characteristics and advantages of the present invention described above and additional features and benefits will be readily apparent to those skilled in the art upon consideration of the following description of embodiments and referring to the accompanying drawings.

What follows are some of, but not all, the objects of this invention. In addition to the specific objects stated below for at least certain embodiments of the invention, other objects and purposes will be readily apparent to one of skill in this art who has the benefit of this invention's teachings and disclosures. It is, therefore, an object of at least certain embodiments of the present invention to provide the embodiments and aspects listed above and:

New, useful, unique, efficient, non-obvious screen assemblies, vibratory separators and shale shakers with such a screen assembly or assemblies, and method of their use;

Such separators and shakers with vertically mounted screen assemblies each having two, three, four or more spaced-apart screening faces or members;

Such screen assemblies which are mountable vertically and which have screening material on spaced-apart sides or faces of a screen assembly screening material support;

Such screen assemblies with an exit opening in a bottom, side, sides, and/or top thereof;

Such screen assemblies with a pump suction or a vacuum applied to an exit opening; and

Such systems which, in certain aspects, provide significantly increased screening material area.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWINGS

A more particular description of certain embodiments of the invention may be had by references to the embodiments which are shown in the drawings which form a part of this specification.

FIG. 1 is a perspective view of a screen assembly according to the present invention with a screening material (which covers two entire side openings) shown cutaway.

FIG. 2 is a perspective view of a screen assembly according to the present invention with a screening material (which covers two entire side openings) shown cutaway.

FIG. 2A is a perspective view of an alternative embodiment of the screen assembly of FIG. 2.

FIG. 3A is a side view of a system assembly according to the present invention.

FIG. 3B is a cross-section view along line 3B-3B of FIG. 3A.

FIG. 4 is a side view of a shale shaker according to the present invention.

FIG. 4A is an end schematic view of a vibratory separator according to the present invention.

FIG. 5 is a side cutaway view of a shale shaker according to the present invention.

FIG. 6 is a perspective view of a screen support of a screen assembly used in the shale shaker of FIG. 6.

FIG. 7 is a side view of a panel used with a screen assembly of the shale shaker of FIG. 5.

FIG. 8A is a top schematic view of a shale shaker according to the present invention.

FIG. 8B is a top view of part of the shale shaker of FIG. 8A.

FIG. 8C is a top view of a part of the shale shaker of FIG. 8A.

Certain embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of certain embodiments and are not intended to limit the invention or the appended claims. On the contrary, the intention is to cover all modifications, equivalents and alternatives falling within the spirit and scope of the invention as defined by the appended claims. In showing and describing these embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiments, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein.

### DESCRIPTION OF EMBODIMENTS PREFERRED AT THE TIME OF FILING FOR THIS PATENT

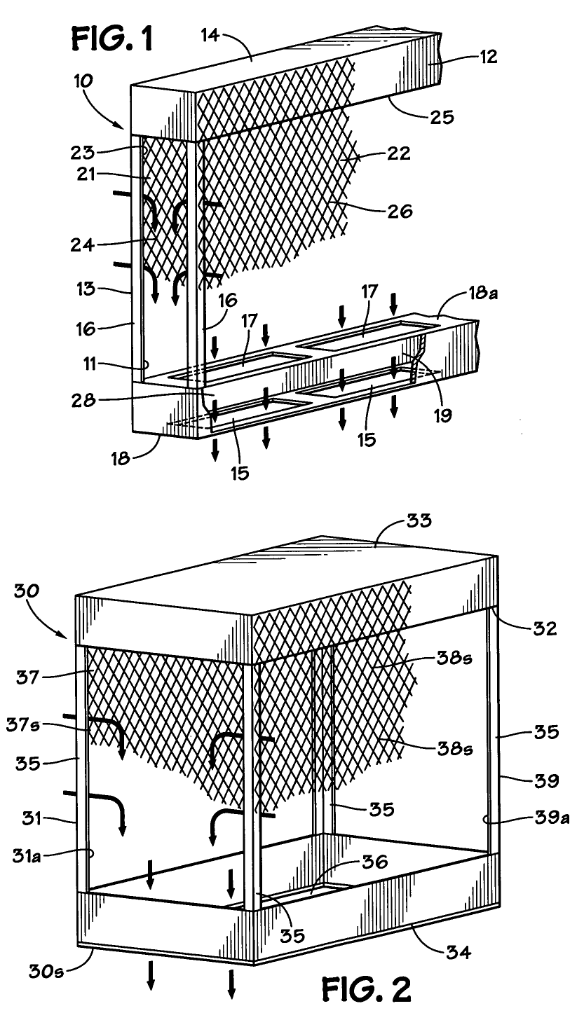

FIG. 1 shows a screen assembly 10 according to the present invention with a support 12 having a top 14, support bars 16 and a bottom 18. The screen assembly 10 has two screening faces 21, 22. The screening face 21 has an opening 23 over which is secured screening material 24. The screening face 22 has an opening 25 over which is secured screening material 26. Although the screening material 24 and 26 is shown partially, it is to be understood that the entire openings 23 and 25 are covered with the screening material.

The screening material 24 and 26 may be any layer or layers of known suitable screening mesh or cloth, with layers connected together or not. A support such as a perforated plate or strip support may be used on one or both screen faces to support the screening material (e.g., but not limited to, a perforated plate as shown in FIG. 3B). Both layers of screening material 24, 26 are, as shown, made of similar mesh; but it is within the scope of the present invention for these two layers (and any two screening faces of any embodiment of the present invention) to have different meshes in the two layers.

One, two, three or more passageways are provided in the support 12 through which material (e.g. fluid plus some solids or fluid alone) which has passed through a screening face can flow. From the passageway(s), the material exits the screen assembly. as is true for any screen assembly according to the present invention, the passageway(s) may be at any point in and through the support, e.g., but not limited to, through a bottom or through a top of the support. As shown in FIG. 1, the bottom 18 has at least one passageway 28 therethrough so that fluid flowing through the screen faces 21, 22 and flowing downwardly can exit the screen assembly. As shown the passageways 28 extend through a tubular part 18a which has a hollow interior 19, an upper hole 17 and a lower hole 15. Arrows indicate flow through the faces 21, 22, the holes 17, and the holes 15.

An end 13 of the support 12 (and an opposite end, like the end 13, not shown) can be solid or, as shown, may be open with an opening 11. By mounting the screen assembly 10 in sealing relationship with mounting structure of a vibratory separator or shaker, the openings 11 are closed off to fluid flow.

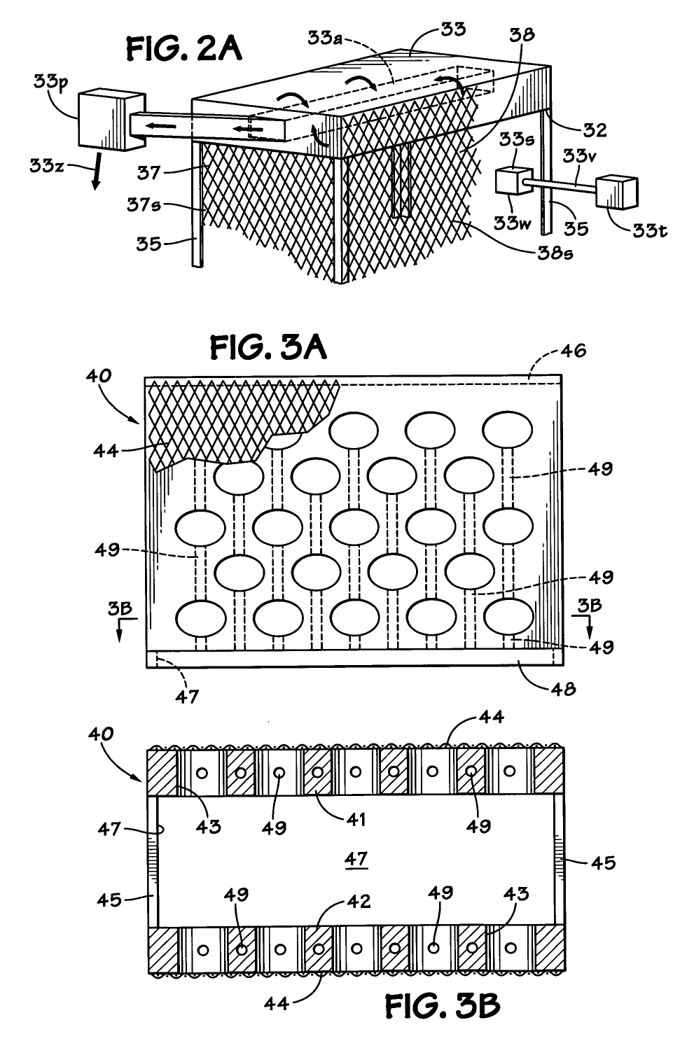

FIG. 2 shows a screen assembly 30 according to the present invention with a support 32 which has a top 33, a bottom 34 and supports 35. The screen assembly 30 has two spaced-apart screening faces 37, 38 each with screening material 37s, 38s thereon (respectively). The bottom 34 has an opening 36 through which fluid that has flowed through the faces 37, 38 can exit the screen assembly 30. Optionally, a seal 30s seals a basket/screen-assembly interface. Optionally, the seal 30s or some other seal is on the basket to seal this interface.

Ends 31 and 39 of the support 32 have openings 31a and 39a, respectively; but, according to the present invention, the ends 31 and 39 may be solid with no opening.

The mesh of the faces 37, 38 may be the same or, as shown, may be different. Any known layer or layers of screening material mesh or cloth may be use don the faces 37, 38 connected or unconnected, with or without a support such as a perforated plate or strip support.

FIG. 2A shows an optional opening 33a in the top 33 (in which the top 33 is a solid piece; of course as shown in FIG. 2 the top 33 may be solid or it may have a substantially hollow interior) of the support 32 and an optional apparatus 33p (shown schematically) for drawing material through the opening 33a (e.g., but not limited tom a pump or a vacuum apparatus). The material is then provided to other processing apparatus, disposal, or storage (arrow 33z). Either a pump suction or a vacuum can be applied at any exit opening of any screen assembly according to the present invention. Optionally, as shown in FIG. 2A, pump suction or a vacuum can be applied to a screen assembly according to the present invention, e.g. by an apparatus 33t via a conduit 33v and an aperture 33w.

FIGS. 3A and 3B show a screen assembly 40 according to the present invention which has two spaced-apart perforated plates 41, 42, each with a plurality of holes 43 therethrough. Screening material 44 (shown cutaway in FIG. 3A) covers the plates 41, 42 and the holes 43. Bars 45 connect the plates 41, 42 together. Optionally a solid plate 46 closes off the top of the screen assembly 40. Fluid can flow through the screening material 44 and down within the space between the two plates 41, 42 to exit from the screen assembly 40 through a bottom opening 47 in a base 48.

Optionally, the plates 41, 42 have a plurality of holes 49 through which fluid can flow down to the opening 47. Although perforated plates are shown, any known support (frame—e.g. solid or hollow tubular—strip support, etc.) can be used with the screening material 44 (as may be the case with any embodiment according to the present invention). The screening material 44 can be any layer or layers of known screening material, mesh, or cloth, connected or unconnected.

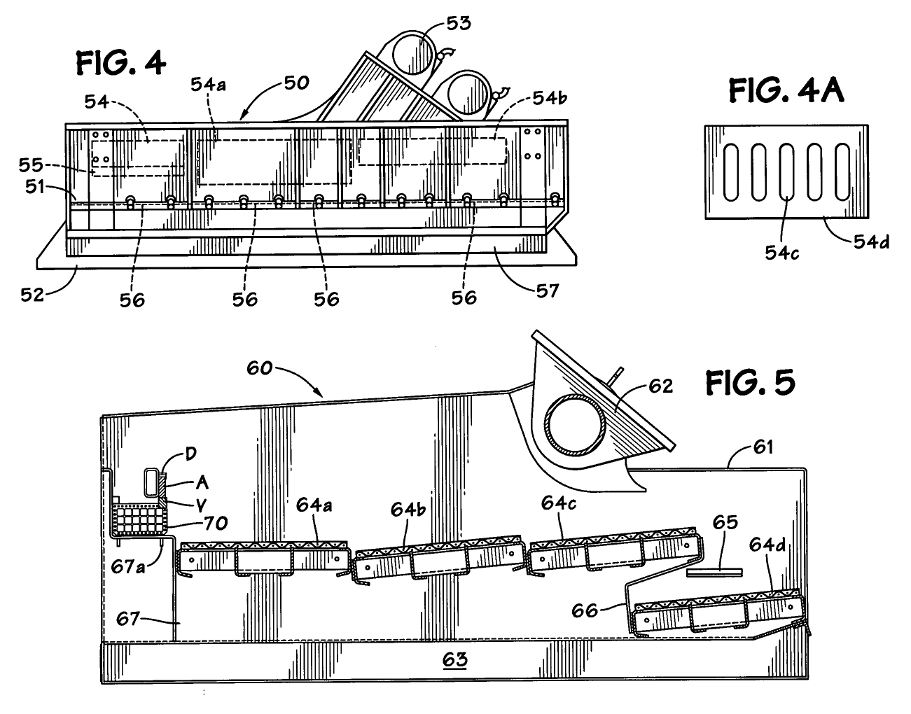

FIG. 4 shows a shale shaker 50 according to the present invention which has a basket 51 on a base 52 and vibratory apparatus 53 for vibrating the basket 51 and screens mounted therein. A screen 54 (which may be any vertically mountable screen according to the present invention) is mounted in the basket 51 on a mount 55. Two, three, four or more such screens may be mounted in the basket 51. Optionally, one or more typical horizontally-mounted (or generally horizontal) screens 56 can also be used. Fluid exits the basket 51 into a container or receptacle 57. Optionally, multiple vertically mounted screens are used; e.g. screens 54a and/or 54b.

As shown in FIG. 4A, it is within the scope of the present invention to have multiple spaced-apart screen assemblies 54c according to the present invention positioned side-by-side in a basket 54d of a shaker. The screen assemblies 54c may be any screen assembly according to the present invention.

FIG. 5 shows a shale shaker 60 according to the present invention which has a basket 61, vibratory apparatus 62, a fluid reception receptacle 63 (e.g. a sump or other container), a plurality of generally-horizontally mounted screens 64a-64d, an optional fluid diffuser 65, and an optional flowback pan 66. A plurality of vertically-mounted screen assemblies 70 (one visible in the view of FIG. 5) are positioned on a mount 67.

The screen assemblies 70 are located at a feed end of the shaker 60 for receiving part of an initial feed of material to the shaker 60. Fluid exiting the screen assemblies 70 flows into the receptacle 63 (not to the screens 64a-64d). An appropriate opening or openings 67a are provided through the mount 67 for fluid to flow from the screens 70 into the mount 67. Optionally, as in FIG. 2A, the fluid could be drawn from the tops and/or sides of the screens 70.

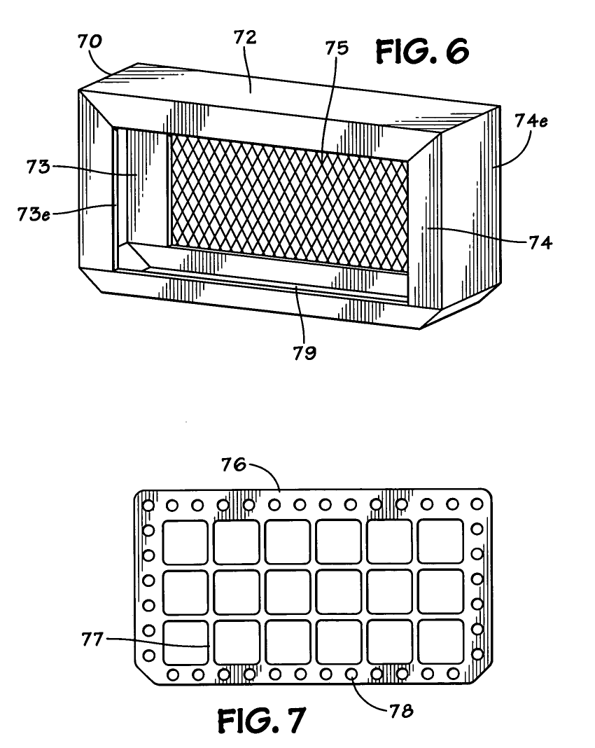

As shown in FIGS. 6 and 7, the screen assemblies 70 have a support 72 with two spaced-apart open sides 73, 74 over which is secured screening material 75 (shown only on side 73; present, but, for clarity and the illustration, removed from side 74 in FIG. 6). Optionally a panel 76 of e.g. carbon steel, composite, or fiberglass material is applied on the screening material 75 and secured to the support 72, e.g. fasteners and/or adhesive, e.g. with epoxy. The panel 76 has a plurality of spaced-apart openings 77 and holes 78. Adhesive projecting through the holes 78 facilitates securement of the panel 76 to the screening material 75 and to the support 72. Optionally there are openings in the ends 73e, 74e and screening material over these ends.

As is true for any screen assembly according to the present invention, the screening material can overlap on (and be secured on) the exterior of a screen support (e.g. see the screen 26, FIG. 1) or onto the interior of a support (see material 75. FIG. 6).

Fluid flowing into the screen assemblies 70 through the screening material 75 flows down to an opening 79 in the support 72 and from there to e.g. a receptacle 63, FIG. 5.

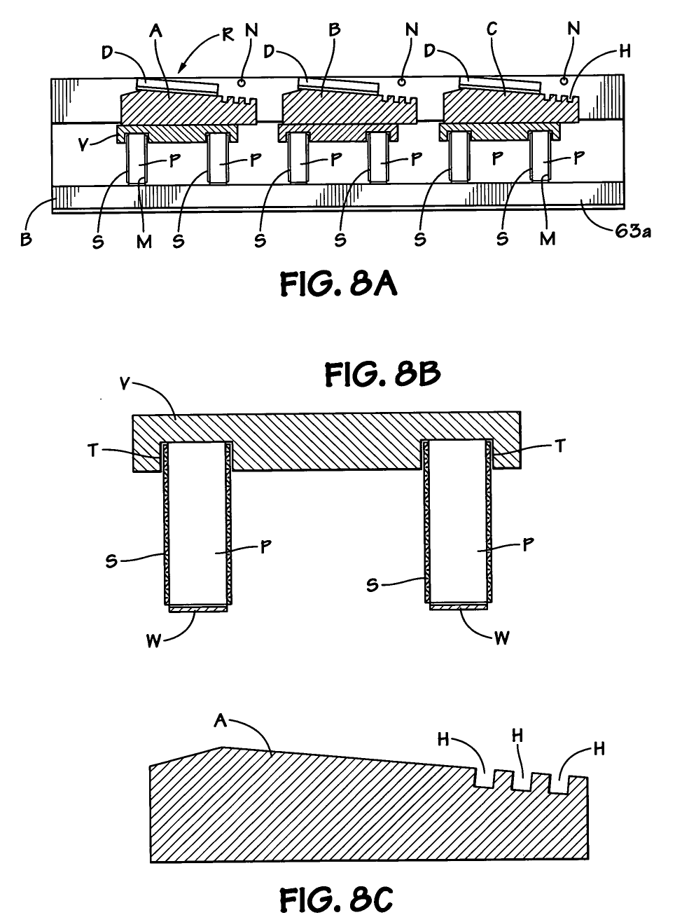

FIG. 8A shows a shale shaker R according to the present invention with a series of wedges A, B, C each holding in place two spaced-apart vertically mounted screen assemblies S (like the screen assemblies 70, FIG. 5 or any vertically-mountable screen assembly according to the present invention). The screen assemblies S are secured between a beam B and the wedges A, B, C. Fluid flowing into spaces P within each screen assembly S flows down and then out of a bottom opening M in each screen assembly, e.g. down to a receptacle 63a, like the receptacles 63 as in FIG. 5. The wedges A, B, C abut bars D secured to the shaker R.

A top of each screen assembly S is received and held in a recess T of a screen mount V. Seals W seal a basket-beam-B/screen-assembly-S interface. Wedges A, B, C releasably hold the screen assemblies S in place and enhance sealing against the seals W.

A bar or other member placed with an end in a notch H of a wedge A, B, or C and abutting a pin N as a fulcrum is used to move the wedges A, B, C forcibly against the bars D to releasably secure the wedges in place. Alternatively the bar or other member is used as a lever to loosen the wedges A, B, C (again utilizing the notches H and the pins N).

The present invention, therefore, provides in some and not necessarily all embodiments, a screen assembly for a vibratory separator, the screen assembly vertically-mountable and including: a support, the support vertically mountable in a vibratory separator; at least two screening faces on the support, said at least two screening faces each including screening material through which fluid is flowable from outside the screen assembly into a space within the screen assembly and interiorly of the at least two screening faces; and the support including an exit from which fluid flowing through the at least two screening faces exits from within the screen assembly. Such a screen assembly according to the present invention may have one or some (in any possible combination) of the following: each screening face is on a side of the screen assembly; the exit is at a bottom of the screen assembly; the exit is at a side of the screen assembly; the exit is at a top of the screen assembly; the support has a bottom tubular part with holes therethrough comprising the exit; each screening face includes a perforated plate with plate holes therein for conducting fluid down to the exit; the plate holes includes a plurality of vertical holes within each plate extending from a top of the plate to the bottom of the plate; and/or the plate holes include a plurality of holes through each plate from one side thereof to the other.

The present invention, therefore, provides in some and not necessarily all embodiments, a screen assembly for a vibratory separator, the screen assembly vertically-mountable and including: a support, the support vertically mountable in a vibratory separator; at least two spaced-apart screening faces on the support, said at least two screening faces including screening material through which fluid is flowable from outside the screen assembly into a space within the screen assembly and interiorly of the at least two screening faces; the support including an exit from which fluid flowing through the at least two screening faces exits from within the screen assembly; wherein each screening face is on a side of the screen assembly; wherein the exit is at a bottom of the screen assembly; and wherein the support has a bottom tubular part with holes therethrough comprising the exit.

The present invention, therefore, provides in some and not necessarily all embodiments, a shaker for separating components of feed material fed to the shaker, the shaker including: a basket for supporting screening apparatus for treating feed material; vibratory apparatus connected to the basket for vibrating the basket and the screening apparatus; the screening apparatus is at least one screen assembly, the at least one screen assembly mounted vertically in the basket, the at least one screen assembly is a support, the support vertically mountable in a vibratory separator, at least two screening faces on the support, the at least two screening faces including screening material through which fluid is flowable from outside the screen assembly into a space within the screen assembly and interiorly of the at least two screening faces, and the support including an exit from which fluid flowing through the at least two screening faces exits from within the screen assembly; and a lower receptacle for receiving material from the screening apparatus. Such a screen assembly according to the present invention may have one or some (in any possible combination) of the following: the at least one screen assembly is a plurality of spaced-apart screen assemblies; the feed material is drilling fluid with solids therein; each screening face is on a side of the screen assembly; the exit of the screen assembly is at a bottom of the screen assembly; the support of the screen assembly has a bottom tubular part with holes therethrough for the exit; apparatus in communication with the exit for sucking material through the exit; and/or each screening face includes a perforated plate with plate holes therein for conducting fluid down to the exit.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112. The inventors may rely on the Doctrine of Equivalents to determine and assess the scope of their invention and of the claims that follow as they may pertain to apparatus not materially departing from, but outside of, the literal scope of the invention as set forth in the following claims. All patents and applications identified herein are incorporated fully herein for all purposes. It is the express intention of the applicant not to invoke 35 U.S.C. §112, paragraph 6 for any limitations of any of the claims herein, except for those in which the claim expressly uses the words ‘means for’ together with an associated function. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

What is claimed is:

1. A screen assembly for a vibratory separator, the screen assembly vertically-mountable and further comprising
a support, the support vertically mountable in a vibratory separator,
at least two screening face on the support, said at least two screening faces each including screening material through which fluid is flowable from outside the screen assembly into a space within the screen assembly and interiorly of the at least two screening faces, and
the support including an exit from which fluid flowing through the at least two screening faces exits from within the screen assembly.

2. The screen assembly of claim 1 wherein
the at least two screening faces are spaced-apart screening faces.

3. The screen assembly of claim 2 wherein each screening face is on a side of the screen assembly.

4. The screen assembly of claim 1 wherein the exit is at a bottom of the screen assembly.

5. The screen assembly of claim 1 wherein the exit is at a side of the screen assembly.

6. The screen assembly of claim 1 wherein the exit is at a top of the screen assembly.

7. The screen assembly of claim 1 wherein
the support has a bottom tubular part with holes therethrough comprising the exit.

8. The screen assembly of claim 1 wherein
each screening face includes a perforated plate with plate holes therein for conducting fluid down to the exit.

9. The screen assembly of claim 8 wherein the plate holes includes a plurality of vertical holes within each plate extending from a top of the plate to the bottom of the plate.

10. The screen assembly of claim 8 wherein the plate holes include a plurality of holes through each plate from one side thereof to the other.

11. A screen assembly for a vibratory separator, the screen assembly vertically-mountable and further comprising
a support, the support vertically mountable in a vibratory separator,
at least two spaced-apart screening faces on the support, said at least two screening faces each including screening material through which fluid is flowable from outside the screen assembly into a space within the screen assembly and interiorly of the at least two screening faces,
the support including an exit from which fluid flowing through the at least two screening faces exits from within the screen assembly,
wherein each screening face is on a side of the screen assembly,
wherein the exit is at a bottom of the screen assembly, and
wherein the support has a bottom tubular part with holes therethrough comprising the exit.

12. A shaker for separating components of feed material fed to the shaker, the shaker comprising
a basket for supporting screening apparatus for treating feed material,
vibratory apparatus connected to the basket for vibrating the basket and the screening apparatus,
the screening apparatus comprising at least one screen assembly, the at least one screen assembly mounted vertically in the basket, the at least one screen assembly comprising a support, the support vertically mountable in a vibratory separator, at least two screening faces on the support, said at least two screening faces each including screening material through which fluid is flowable from outside the screen assembly into a space within the screen assembly and interiorly of the at least two screening faces, and the support including an exit from which fluid flowing through the at least two screening faces exits from within the screen assembly, and
a lower receptacle for receiving material from the screening apparatus.

13. The shaker of claim 12 wherein the at least one screen assembly is a plurality of spaced-apart screen assemblies.

14. The shaker of claim 12 wherein the feed material is drilling fluid with solids therein.

15. The shaker of claim 12 wherein each screening face is on a side of the screen assembly.

16. The shaker of claim 12 wherein the exit of the screen assembly is at a bottom of the screen assembly.

17. The shaker of claim 12 wherein the support of the screen assembly has a bottom tubular part with holes therethrough comprising the exit.

18. The shaker of claim 12 further comprising
apparatus in communication with the exit for sucking material through the exit.

19. The shaker of claim 12 wherein
each screening face includes a perforated plate with plate holes therein for conducting fluid down to the exit.

20. A method for processing material with a vibratory separator, the method comprising
introducing feed material to a vibratory separator, the vibratory separator comprising a basket for supporting screening apparatus for treating feed material, vibratory apparatus connected to the basket for vibrating the basket and the screening apparatus, the screening apparatus comprising at least one screen assembly, the at least one screen assembly mounted vertically in the basket, the at least one screen assembly comprising a support, the support vertically mountable in a vibratory separator, at least two screening faces on the support, said at least two screening faces each including screening material through which fluid is flowable from outside the screen assembly into a space within the screen assembly and interiorly of the at least two screening faces, and the support including an exit from which fluid flowing through the at least two screening faces exits from within the screen assembly, and a lower receptacle for receiving material from the screening apparatus, the feed material including fluid and solids,
separating fluid from the feed material with the screening apparatus, and
separated fluid flowing from within the screening apparatus to the lower receptacle.
